(19) United States
(12) Patent Application Publication
(10) Pub. No.: US 2004/0063444 A1
(43) Pub. Date: Apr. 1, 2004

(54) Method for information exchange between several mobile telephone users

(76) Inventors: Philippe Tissot, Paris (FR); Fabien Thiriet, Orleans (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/204,424

(22) PCT Filed: Feb. 28, 2001
(86) PCT No.: PCT/FR01/00574

(30) Foreign Application Priority Data
Feb. 29, 2000 (FR) 00/02503

(51) Int. Cl. H04Q 7/24; G08B 29/00

(52) U.S. Cl. 455/466; 340/509; 370/338; 455/41.2

(57) ABSTRACT

A method for exchanging, in real time, information between several persons provided with a mobile telephone adapted to be connected to a server. The method includes, for a user, transmitting to the server an identification signal, displaying on a screen of a first mobile telephone a list of persons having transmitted the identification signal, selecting from the list persons with whom the user wishes to exchange information, transmitting to the server a request for being connected to selected person, and interconnecting the first mobile telephone with the mobile telephones of the selected persons. Thus the interconnected persons can exchange information data in real time.

This invention relates to a method for exchanging, in real time or quasi real time, information, in particular written or audio messages, between several members of a population of people using mobile telephones, capable of being connected to a server via a communication network.

There are significant limits on the exchange of written or audio messages between mobile telephone users and, as a consequence, on the formation of discussion forums and the management of communities of users.

Current solutions do not allow systems already implemented on other communication networks, in particular on the Internet, to be transposed to mobile telephone systems. There are the following drawbacks: consulting messages in an asynchronous manner is not possible, sending a messages is always determinist (the recipients of a message must always be determined before sending a message) and users cannot be grouped according to their profile or interests.

The method according to the invention permits an exchange, in real time or quasi real time, of information, in particular written or audio messages, between several members of a population of people using mobile telephones, capable of being connected to a server via a communication network.

This method comprises several steps.

It comprises the step of transmitting an identification signal to the aforementioned server, from each mobile telephone used by a person wishing to exchange information in real time. The aforementioned signal contains information regarding the status of the mobile telephone in question. Status, in the sense of this invention, means “connected” or “connected and busy” or “connected and free” or “connected and hidden” or “connected and making a request” or “disconnected for a limited period” statuses. The aforementioned status is determined by the server and/or parameterised by the user of each mobile telephone. Where the aforementioned status is parameterised by the server, it is not necessary to transmit an identification signal containing the aforementioned status to the aforementioned server.

The method also comprises the following steps:

the step of periodically drawing up and memorising in the aforementioned server a list of people wishing to exchange information and who have transmitted the aforementioned identification signal, using their mobile telephone.

the step of viewing on the screen of a first mobile telephone and/or transmitting from a first mobile telephone using a speaker the aforementioned list, or a restricted list of selected people from those on the aforementioned list,

This restricted list can in particular be created by the user using the control functions on his mobile telephone. This restricted list can also be created in a quite different manner and memorised in the server, as explained below.

In an initial embodiment, the method comprises the step of transmitting to the aforementioned server, from the first mobile telephone, a download request signal. The download request signal from the aforementioned first mobile telephone relates to the status of the mobile telephones used by the people appearing on the aforementioned list or on the restricted list.

Alternatively, in a second embodiment, the method comprises the step of transmitting, from the server to the first mobile telephone, the status of the mobile telephones used by the people appearing on the aforementioned list or on the restricted list.

Thus, whatever the embodiment, the user of the aforementioned first mobile telephone knows at any time which people he can exchange information with.

In one embodiment, the method also comprises the step of transmitting to the aforementioned server, from the aforementioned first mobile telephone, a voice or text interconnection request signal, with all or some of the mobile telephones used by the people appearing on the aforementioned list or the restricted list, taking into account the status of their mobile telephone.

In another embodiment, an alternative to the previous embodiment, the method comprises the step of transmitting to the aforementioned first mobile telephone, from the server, a voice or text interconnection request, with one or more mobile telephones used by the people appearing on the aforementioned list or the restricted list, taking into account of the status of their mobile telephone, in particular the connected and making a request status.

Thus, whatever the embodiment, those people who are interconnected can exchange information in real time or quasi real time.

There are several ways of establishing the aforementioned restricted list of selected people.

Preferably, in one embodiment, the server transmits to the aforementioned first mobile telephone, either directly or on the request of the aforementioned first mobile telephone, the aforementioned list in such a form that the user can familiarise himself with it in an audio and/or visual manner and can select from the aforementioned list a restricted list.

Preferably, in another embodiment, the user establishes all or part of the aforementioned restricted list himself, in particular in favour of contacts with other members.

Favourably, according to the invention, the user transmits to the server the aforementioned restricted list or the changes made to the aforementioned restricted list, using the aforementioned first mobile telephone.

Preferably, according to the invention, the server periodically transmits to the aforementioned first mobile telephone, the aforementioned list or the updated restricted list.

Preferably, according to the invention, the “connected and making a request” status comprises the following requests:

request to automatically establish an interconnection with mobile telephones, which have made the same request,

request defining the areas of interest,

request to change status.

The method according to the invention is more particularly designed to search for people located in close proximity to each other. In a recognised fashion, the aforementioned communication network is subdivided into cells, each one corresponding to a certain geographic area. The aforementioned cells are identified by a cell number. The cell numbers where the aforementioned mobile telephones are situated are transmitted and stored in a memory sector of the aforementioned server. The cell numbers can also be transmitted and stored in a memory sector of the aforementioned mobile telephones. The method also comprises, in the above case, the step of transmitting the aforementioned cell number to the aforementioned server, from each mobile telephone used by a person wishing to exchange information in real time.

The method, designed to search for people located in close proximity to each other, also comprises the following steps:

the step of determining, using the aforementioned cell numbers, which mobile telephones are located in the same cell or in neighbouring cells,

the step of downloading the aforementioned list or the aforementioned restricted list to the aforementioned first mobile telephone, indicating with an audio or visual symbol, the people whose mobile telephones are located either in the same cell as the one in which the mobile telephone in question is located, or in cells adjoining the one in which the aforementioned first mobile telephone is located.

Thus, the person using the aforementioned first mobile telephone can identify the people located in his geographic area and can contact them in order to meet them.

The invention also relates to a system for exchanging information, in real time or quasi real time, in particular written or audio messages, between several members of a population of people using mobile phones capable of being connected to a server via a communication network.

The aforementioned system comprises the processing tools to generate an identification signal. The aforementioned identification signal contains information relating to the status of the mobile telephone in question. Status, in the sense of this invention, means “connected” or “connected and busy” or “connected and free” or “connected and hidden” or “connected and making a request” or “disconnected for a limited period” statuses.

The aforementioned server of the aforementioned system comprises the calculation tools to determine the aforementioned status, and/or the aforementioned mobile telephone comprises the parameterisation tools to parameterise the aforementioned status. The aforementioned parameterisation tools can be operated by the mobile telephone user.

The aforementioned mobile telephone comprises the transmission tools to transmit to the aforementioned server all or part of the aforementioned identification signal.

The aforementioned server of the aforementioned system also comprises the calculation and memorisation tools to periodically draw up and memorise the list of people wishing to exchange information and who have sent all or part of the aforementioned identification signal, using their mobile telephones.

The aforementioned mobile telephones also comprise the tools to view on their screens the aforementioned list, or a restricted list of selected people from those on the aforementioned list, and/or a speaker to transmit the aforementioned list, or a restricted list of selected people from those on the aforementioned list.

In an initial embodiment of the aforementioned system, each mobile telephone also comprises the transmission tools to transmit to the aforementioned server a download signal request for the status of the mobile telephones used by people appearing on the aforementioned list, or the restricted list, to the mobile telephone in question.

Alternatively, in a second embodiment of the aforementioned system, the aforementioned server comprises the transmission tools to transmit to the mobile telephone in question, the status of the mobile telephones used by people appearing on the aforementioned list, or the restricted list.

Thus, whatever the embodiment of the aforementioned system, the user of the aforementioned mobile telephone in question knows at any time which people he can exchange information with.

In an embodiment of the aforementioned system, the aforementioned mobile telephone in question comprises the transmission tools to transmit to the aforementioned server a voice or text interconnection request signal, with all or some of the mobile telephones used by the people appearing the aforementioned list or on the restricted list, taking into account the status of their mobile telephones.

In another embodiment of the aforementioned system, an alternative to the previous embodiment, the aforementioned server comprises the transmission tools to transmit to each mobile telephone a voice or text interconnection request with one or more of the mobile telephones used by the people appearing on the aforementioned list or on the restricted list, taking into account the status of their mobile telephones, in particular with a connected and making a request status.

Thus, whatever the embodiment, interconnected people can exchange information in real time or quasi real time.

Preferably, to establish the aforementioned restricted list of selected people, the server of the aforementioned system comprises the transmission tools to transmit to the mobile telephone in question, either directly or on a request from the aforementioned mobile telephone in question, the aforementioned list in such a form that the user can familiarise himself with it in an audio and/or visual manner and can select from the aforementioned list a restricted list.

More advantageously, the transmission tools for the aforementioned system comprise the tools to periodically transmit to the mobile telephone in question the aforementioned list or the updated restricted list.

More advantageously, the mobile telephone in question comprises the transmission tools to transmit to the server the aforementioned restricted list or changes made to the aforementioned restricted list.

Preferably, the “connected and making a request” status comprises the following requests:

request to automatically establish an interconnection with mobile telephones, which have made the same request,

request defining the areas of interest,

request for a change of status.

The system according to the invention, is more particularly designed to search for people located in close proximity to each other. In a recognised fashion, the aforementioned communication network is subdivided into cells, each one corresponding to a certain geographic area. The aforementioned cells are identified by a cell number. The cell numbers where the aforementioned mobile telephones are situated are stored in a memory sector of the aforementioned server. The aforementioned mobile telephones may also comprise a memory sector in which are stored the cell numbers where they are located. The aforementioned mobile telephone, in the above case, also comprises the transmission tools to transmit the aforementioned cell number to the aforementioned server.

The aforementioned server also comprises the calculation tools to determine, using the aforementioned cell numbers, which mobile telephones are located in the same cell or in neighbouring cells.

The aforementioned server also comprises the downloading tools to download the aforementioned list or the aforementioned restricted list to the mobile telephone in question by marking with an audio or visual symbol, the people whose mobile telephones are located either in the same cell as the one in which the aforementioned first mobile telephone is located, or in cells adjoining the one in which the mobile telephone in question is located.

Thus, the person using the mobile telephone in question can identify the people located in his geographic area and can contact them in order to meet them.

The invention also relates to a server permitting several members of a population of people to exchange information, in real time or quasi real time, in particular written or audio messages.

The aforementioned people use mobile telephones capable of being connected to the aforementioned server via a communication network.

The aforementioned server comprises the calculation tools to determine the status of the mobile telephone in question.

Status, in the sense of this invention, means “connected” or “connected and busy” or “connected and free” or “connected and hidden” or “connected and making a request” or “disconnected for a limited period” statuses.

The aforementioned server also comprises the calculation and memorisation tools to periodically draw up and memorise the list of people wishing to exchange information, the aforementioned people having transmitted all or part of an identification signal, using their mobile telephone, the aforementioned identification signal containing information relating to the status of the mobile telephone in question.

The aforementioned server also comprises the transmission tools to transmit to the mobile telephone in question the status of the mobile telephones used by the people appearing on the aforementioned list or on the restricted list.

Thus, the user of the aforementioned mobile telephone in question can identify at any time the people with whom he can exchange information.

The aforementioned server also comprises the transmission tools to transmit to each mobile telephone a voice or text interconnection request signal with one or more mobile telephones used by people appearing on the aforementioned list or on the restricted list, taking into account the status of their mobile telephones, in particular the connected and making a request status.

Thus, interconnected people can exchange information in real time or quasi real time.

Preferably, the server according to the invention comprises the transmission tools to transmit to the mobile telephone in question, either directly or on a request from the aforementioned mobile telephone in question, the aforementioned list in such a form that the user can familiarise himself with it in an audio and/or visual manner and can select from the aforementioned list a restricted list.

Preferably, the server according to the invention comprises the transmission tools to periodically transmit to the mobile telephone in question the aforementioned list or the updated restricted list.

Preferably, according to the invention, the “connected and making a request” status comprises the following requests:

request to automatically establish an interconnection with mobile telephones, which have made the same request,

request defining the areas of interest,

request to change status.

The server according to the invention is more particularly designed to search for people located in close proximity to each other. In a recognised fashion, the aforementioned communication network is subdivided into cells, each one corresponding to a certain geographic area. The aforementioned cells are identified by a cell number.

The aforementioned server comprises a memory sector in which the cell numbers where the aforementioned mobile telephones are located are stored.

The aforementioned server also comprises the calculation tools to determine, using the aforementioned cell numbers, which mobile telephones are located in the same cell or in neighbouring cells.

The aforementioned server also comprises the downloading tools to download the aforementioned list or the aforementioned restricted list to the mobile telephone in question by marking with an audio or visual symbol, the people whose mobile telephones are located either in the same cell as the one in which the mobile telephone in question is located, or in cells adjoining the one in which the mobile telephone in question is located.

Thus, the person using the mobile telephone in question can identify the people located in his geographic area and can contact them in order to meet them.

Other characteristics and advantages of the invention will become evident when the description of the embodiments of the invention is read. These are provided as an indicative and non-limitative example, and include:

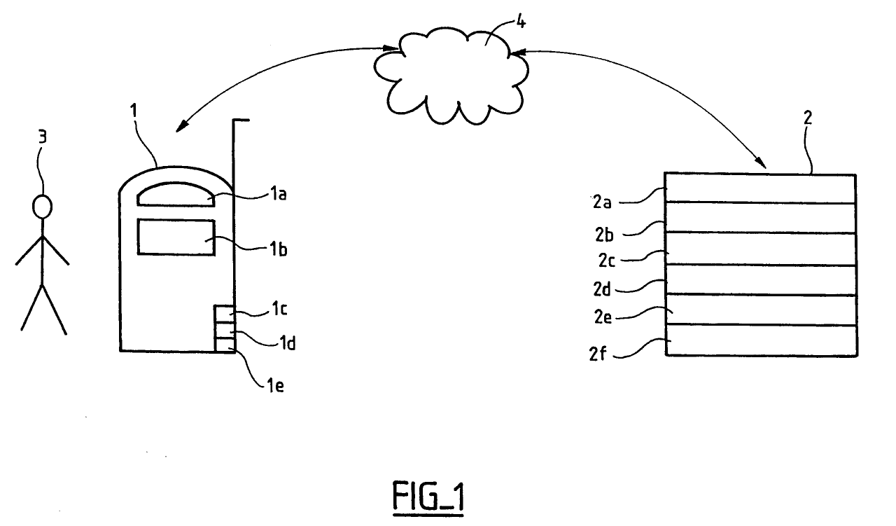

FIG. 1 showing a diagrammatic representation of a user wishing to exchange information and using a mobile phone connected to a server via a communication network,

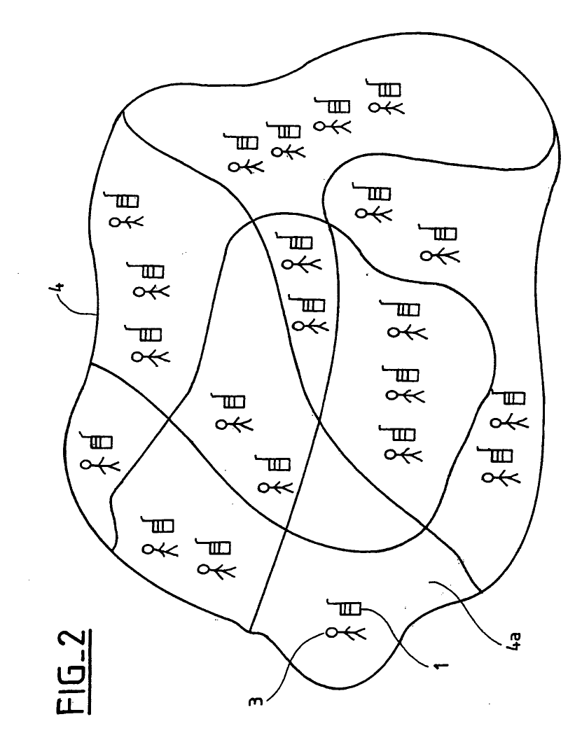

FIG. 2 showing a diagrammatic representation of a communication network divided into cells, each one representing a certain geographic area,

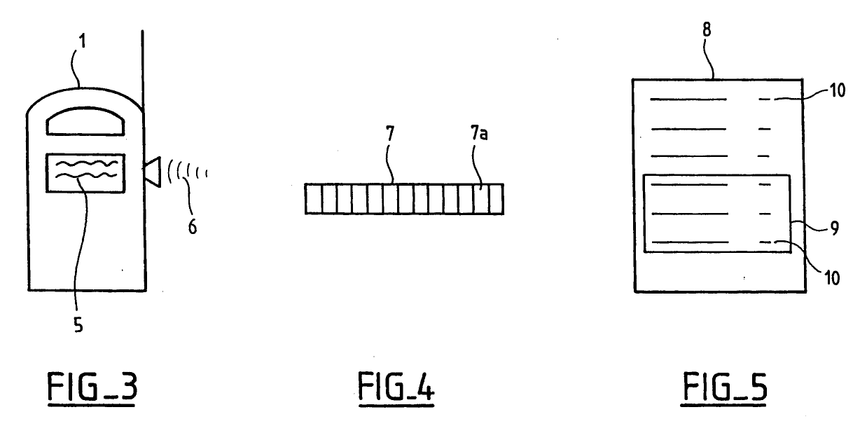

FIG. 3 showing a diagrammatic representation of a written message and an audio message transmitted by a mobile telephone,

FIG. 4 showing a diagrammatic representation of an identification signal containing information relating to the status of the mobile telephone,

FIG. 5 showing a diagrammatic representation of the list of people who have sent, using their mobile telephone, the aforementioned identification signal and who wish to exchange information, as well as a restricted list of people selected from those on the aforementioned list.

We shall now describe the figures.

In a continuation of the description, each user is deemed to use a mobile telephone identical to that described below using the references 1, 1a, 1b, 1c, 1d and 1e.

A user 3 wishes to exchange information 5, 6, in real time or quasi real time, in particular written messages 5 or audio messages 6 with other users. This user 3, uses the keys of his mobile telephone 1, to activate the transmission tools of his mobile telephone 1. An identification signal 7 is then transmitted to a server 2, from the aforementioned mobile telephone 1.

This signal 7 contains information 7a relating to the status of the mobile telephone 1. Status means “connected” or “connected and busy” or “connected and free” or “connected and hidden” or “connected and making a request” or “disconnected for a limited period” statuses. This status is determined by the server 2, using calculation tools 2a, and/or parameterised by the user 3 of each mobile telephone 1, using parameterisation tools 1c.

The server 2, using the calculation tools 2 and memorisation tools 2b, periodically draws up and memorises the list 8 of people who have transmitted the aforementioned identification signal 7 and who wish to exchange information 5, 6.

The user 3 reads on the screen 1b of his mobile telephone 1 the aforementioned list 8 or a restricted list 9 of people selected from the people on the aforementioned list 8.

The user can also listen to the list 8 or the restricted list 9 of people selected from the people on the aforementioned list 8 using a speaker on his mobile phone 1.

The user 3, using the keys on his mobile telephone 1, orders his mobile telephone 1 to transmit to the server 2 a download request signal for the statuses of mobile telephones used by people appearing on the aforementioned list 8 or on the aforementioned restricted list 9.

The server 2, using the transmission tools 2c, transmits to the mobile telephone 1 owned by the user 3 the status of the mobile telephones 1 used by the people appearing on the aforementioned list 8 or on the restricted list 9.

Thus, the user 3 of mobile telephone 1 can identify at any time the people with whom he can exchange information 5, 6.

The user 3, using the keys of his mobile telephone 1, orders his mobile phone 1 to transmit to the server 2 a voice or text interconnection request signal, with all or some of the mobile telephones used by people appearing on the aforementioned list 8 or on the restricted list 9, taking into account the status of their mobile telephone.

The server 2 can also transmit, using the transmission tools 2c, to the mobile telephone 1 belonging to the user 3, a voice or text interconnection request with one or more mobile telephones 1 used by people appearing on the aforementioned list 8 or on the restricted list 9, taking into account the status of their mobile telephone 1, in particular the connected and making a request status.

Thus, people who are interconnected can exchange information 5, 6 in real time or quasi real time.

To establish the aforementioned restricted list 9 of selected people, the server 2 transmits, using the transmission tools 2d, to the mobile telephone 1 belonging to the user 3, either directly or on the request of the mobile telephone 1 belonging to the user 3, the aforementioned list 8 in such a form that the user 3 can familiarise himself with it in an audio and/or visual manner and can select from the aforementioned list 8 a restricted list 9.

The user 3 can also establish the aforementioned restricted list 9 himself, in particular in favour of contacts with other users,

The user 3 transmits to the server 2 the aforementioned restricted list 9 or changes made to the aforementioned restricted list 9 using his mobile telephone 1.

The server 2 periodically transmits to the mobile telephone 1 belonging to the user 3 the aforementioned list 8 or the updated restricted list 9.

The “connected and making a request” status comprises the following requests:

request to automatically establish an interconnection with mobile telephones, which have made the same request,

request defining the areas of interest,

request to change status.

We will now explain how it is possible to search for people located in close proximity to each other.

In a recognised fashion, the communication network 4 is subdivided into cells 4a, each one corresponding to a certain geographic area.

The cells 4a are identified by a cell number.

The cell numbers 4a, where the aforementioned mobile telephones 1 are situated, are transmitted and stored in a memory sector 2e of the aforementioned server 2 and/or in a memory sector of the aforementioned mobile telephones 1. In the above case, the cell number is transmitted to the aforementioned server 2, from each mobile telephone 1 used by a person wishing to exchange information in real time.

The server 2, uses calculation tools 2a to determine, using the aforementioned cell numbers, which mobile telephones 1 are located in the same cell 4a or in neighbouring cells 4a.

The server 2 uses downloading tools 2f to download the aforementioned list 8 or the aforementioned restricted list 9 to the mobile telephone 1 belonging to the user 3 by marking with an audio or visual symbol 10, the people whose mobile telephones 1 are located either in the same cell 4a as the one in which the mobile telephone 1 belonging to the user 3 is located, or in cells 4a adjoining the one in which the mobile telephone 1 belonging to the user 3 is located.

Thus, the user 3 of the mobile telephone 1 can identify the people located in his geographic area and can contact them in order to meet them

1. Method for exchanging, in real time or quasi real time, information, in particular written messages (5) or audio messages (6), between several members of a population of people using mobile telephones, capable of being connected to a server (2) via a communication network (4);
the aforementioned method comprises the step of transmitting an identification signal (7) to the aforementioned server (2), from each mobile telephone used by a person wishing to exchange information in real time; the aforementioned identification signal (7) contains information (7a) regarding the status of the mobile telephone in question; this status being:
“connected” status, or
“connected and busy” status, or
“connected and free” status, or
“connected and hidden” status, or
“connected and making a request” status, or
“disconnected for a limited period” status;
the aforementioned status is determined by the server (2) and/or parameterised by the user (3) of each mobile telephone;
the aforementioned method also comprises the following steps:
the step of periodically drawing up and memorising in the aforementioned server (2) the list (8) of people
who have sent the aforementioned identification signal (7), using their mobile telephone and
who wish to exchange information,
the step of viewing on the screen (1b) of a first mobile telephone (1) and/or transmitting from a first mobile telephone (1) using a speaker (1a) the aforementioned list (8), or a restricted list (9) of selected people from those on the aforementioned list (8),
the step:
either of transmitting to the aforementioned server (2) from the first mobile telephone (1) a download request signal to download to the aforementioned mobile telephone (1) the status of the mobile telephones used by the people appearing on the aforementioned list (8) or on the restricted list (9),
or transmitting, from the server (2) to the first mobile telephone (1), the status of the mobile telephones used by the people appearing on the aforementioned list (8) or on the restricted list (9),
(in such a way that the user of the aforementioned first mobile telephone can identify at any time the people with whom he can exchange information),
the step:
either of transmitting to the aforementioned server (2), from the aforementioned first mobile telephone (1), a voice or text interconnection request, with all or some of the mobile telephones used by the people appearing on the aforementioned list (8) or the restricted list (9), taking account of the status of their mobile telephones,
or transmitting to the aforementioned first mobile telephone (1), from the server (2), a voice or text interconnection request, with one or more mobile telephones used by the people appearing on the aforementioned list (8) or the restricted list (9), taking account of the status of their mobile telephone, in particular the connected and making a request status,
(in such a way that the people interconnected in this manner can exchange information in real time or quasi real time).

2. Method according to claim 1, where to establish the aforementioned restricted list (9) of selected people:
the server (2) transmits to the aforementioned first mobile telephone (1), either directly or on the request of the aforementioned first mobile telephone (1), the aforementioned list in such a form that the user (3) can familiarise himself with it in an audio and/or visual manner and can select from the aforementioned list (8) a restricted list (9), and/or
the user (3) establishes the aforementioned restricted list (9) himself, in particular in favour of contacts with other members.

3. Method according to claim 2 where the user (3) transmits to the server (2) the aforementioned restricted list (9) or changes made to the aforementioned restricted list (9), using the aforementioned first mobile telephone (1).

4. Method according to any of the claims 2 or 3, where the server (2) periodically transmits to the aforementioned first mobile telephone (1), the aforementioned list (8) or the updated restricted list (9).

5. Method according to any of the claims 1 to 4, where the “connected and making a request status” comprises the following requests:
request to automatically establish an interconnection with mobile telephones, which have made the same request,
request defining the areas of interest,
request to change status.

6. Method according to any of the claims 1 to 5 more particularly designed to search for people in close proximity to each other;
the aforementioned communication network (4) is subdivided into cells (4a), each one corresponding to a certain geographic area;
the aforementioned cells (4a) are identified by a cell number;
the cell numbers (4a), where the aforementioned mobile telephones are situated, are transmitted and stored in a memory sector (2e) of the aforementioned server or of the aforementioned mobile telephones (le);
the aforementioned method also comprising, in the above case, the step of transmitting the aforementioned cell number to the aforementioned server (2), from each mobile telephone used by a person wishing to exchange information in real time,
the aforementioned method also comprising:
the step of determining, using the aforementioned cell numbers, which mobile telephones are located in the same cell (4a) or in neighbouring cells (4a),
the step of downloading the aforementioned list (8) or the aforementioned restricted list (9) to the aforementioned first mobile telephone (1), indicating with an audio or visual symbol (10), the people whose mobile telephones are located
in the same cell (4a) as the one in which the aforementioned first mobile telephone (1) is located, or
in cells (4a) adjoining the one in which the aforementioned first mobile telephone (1) is located,
(in such a way that the person using the aforementioned first mobile telephone can identify the people located in his geographic area and can contact them in order to meet them)

7. System for exchanging information, in real time or quasi real time, in particular written messages (5) or audio messages (6), between several members of a population of people using a mobile telephone, capable of being connected to a server (2) via a communication network (4);
the aforementioned system comprising the processing tools to generate an identification signal (7); the aforementioned identification signal (7) containing information (7a) relating to the status of the mobile telephone in question; status means:
“connected” status, or
“connected and busy” status, or
“connected and free” status, or
“connected and hidden” status, or
“connected and making a request” status, or
“disconnected for a limited period” status;
the aforementioned server (2) comprising the calculation tools (2a) to determine the aforementioned status, and/or the aforementioned mobile telephone comprising the parameterisation tools (IC) to parameterise the aforementioned status; the aforementioned parameterisation tools (1c) being operated by the user (3) of the mobile telephone;
the aforementioned mobile telephone comprising the transmission tools (id) to transmit to the aforementioned server (2) all or part of the aforementioned identification signal (7);
the aforementioned server (2) also comprising the calculation tools (2a) and memorisation tools (2b) to periodically draw up and memorise the list (8) of people
who have transmitted all or part of the aforementioned identification signal (7), using their mobile telephone and
who wish to exchange information;
the aforementioned mobile telephones also comprising:
the tools to view (1b) on their screens the aforementioned list (8), or a restricted list (9) of selected people from those on the aforementioned list (8), and/or
a speaker (1a) to transmit the aforementioned list (8), or a restricted list (9) of selected people from those on the aforementioned list (8);
the aforementioned system being such that:
each mobile telephone also comprises the transmission tools (id) to transmit to the aforementioned server (2) a download signal request for the status of mobile telephones used by people appearing on the aforementioned list (8), or the restricted list (9), to the mobile telephone in question,
the aforementioned system being such that:
the aforementioned server (2) comprises the transmission tools (2c) to transmit to the mobile telephone in question, the status of the mobile telephones used by people appearing on the aforementioned list (8), or the restricted list (9);
(in such a way that the user of the aforementioned mobile telephone can identify at any time the people with whom he can exchange information),
the aforementioned system being such that:
the mobile telephone in question comprises the transmission tools (1d) to transmit to the aforementioned server (2) a voice or text interconnection request signal, with all or some of the mobile telephones used by the people appearing the aforementioned list (8) or on the restricted list (9), taking into account the status of their mobile telephone,
the aforementioned system being such that:
the aforementioned server (2) comprises the transmission tools (2c) to transmit to each mobile telephone a voice or text interconnection request with one or more of the mobile telephones used by the people appearing on the aforementioned list (8) or on the restricted list (9), taking into account the status of their mobile telephone, in particular with a connected and making a request status,
(in such a way that people interconnected in this manner can exchange information in real time or quasi real time).

8. Method according to claim 7, where to establish the aforementioned restricted list (9) of selected people, the server (2) comprises the transmission tools (2d) to transmit to the mobile telephone in question, either directly or on a request from the aforementioned mobile telephone in question, the aforementioned list (8) in such a form that the user (3) can familiarise himself with it in an audio and/or visual manner and can select from the aforementioned list (8) a restricted list (9).

9. Method according to claim 8, where the mobile telephone in question comprises the transmission tools (1d) to transmit to the server (2) the aforementioned restricted list (9) or changes made to the aforementioned restricted list (9).

10. System according to any of the claims 8 or 9, where the server (2) periodically transmits to the mobile telephone in question the aforementioned list (8) or the updated restricted list (9).

11. System according to any of the claims 7 to 10, where the “connected and making a request” status comprises the following requests:
request to automatically establish an interconnection with mobile telephones, which have made the same request,
request defining the areas of interest,
request to change status.

12. System according to any of the claims 7 to 11, more particularly designed to search for people located in close proximity to each other;
the aforementioned communication network (4) is subdivided into cells (4a), each one corresponding to a certain geographic area;
the aforementioned cells (4a) are identified by a cell number;
the aforementioned server (2) and/or the aforementioned mobile telephones comprise a memory sector (1e, 2e) in which the cell numbers where the aforementioned mobile telephones are located are stored;
the aforementioned mobile telephone, used by a person wishing to exchange information in real time, being such that is also comprises, where it comprises a memory sector (1) designed to store the cell number where it is located, also comprises the transmission tools (id) to transmit the aforementioned cell number to the aforementioned server (2),
the aforementioned server (2) also comprises the calculation tools (2a) to determine, using the aforementioned cell numbers, which mobile telephones are located in the same cell (a) or in neighbouring cells (4a);
the aforementioned server (2) also comprises the downloading tools (2f) to download the aforementioned list (8) or the aforementioned restricted list (9) to the mobile telephone in question by marking with an audio or visual symbol (10), the people whose mobile telephones are located
in the same cell (4a) as the one in which the mobile telephone in question is located, or
in cells (4a) adjoining the one in which the mobile telephone in question is located.
(in such a way that the person using the mobile telephone in question can identify the people located in his geographic area and can contact them in order to meet them).

13. Server (2) permitting several members of a population of people to exchange information, in real time or quasi real time, in particular written messages (5) or audio messages (6); the aforementioned people using mobile telephones capable of being connected to the aforementioned server (2) via a communication network (4);
the aforementioned server (2) comprising the calculation tools (2a) to determine the status of the mobile telephone in question; status means:
“connected” status, or
“connected and busy” status, or
“connected and free” status, or
“connected and hidden” status, or
“connected and making a request” status, or
“disconnected for a limited period” status;
the aforementioned server (2) also comprises the calculation tools (2a) and memorisation tools (2b) to periodically draw up and memorise the list (8) of people wishing to exchange information; the aforementioned people having transmitted all or part of an identification signal (7), using their mobile telephone; the aforementioned identification signal (7) containing information (7a) relating to the status of the mobile telephone in question;
the aforementioned server (2) also comprises the transmission tools (2c) to transmit to the mobile telephone in question the status of the mobile telephones used by the people appearing on the aforementioned list (8) or on the restricted list (9);
(in such a way that the user of the aforementioned mobile telephone can identify at any time the people with whom he can exchange information),
the aforementioned server (2) also comprises the transmission tools (2a) to transmit to each mobile telephone a voice or text interconnection request with one or more of the mobile telephones used by people appearing on the aforementioned list (8) or on the restricted list (9), taking into account the status of their mobile telephones, in particular the connected and making a request status,
(such that people interconnected in this manner can exchange information in real time or quasi real time).

14. Server (2) according to claim 13 comprising the transmission tools (2d) to transmit to the mobile telephone in question, either directly or on the request of the aforementioned mobile telephone, the aforementioned list (8) in such a form that the user (3) can familiarise himself with it in an audio and/or visual manner and can select from the aforementioned list (8) a restricted list (9).

15. Server (2) according to claim 14 comprising the transmission tools (2d) to periodically transmit to the mobile telephone in question, the aforementioned list (8) or the updated restricted list (9).

16. Server (2) according to any of the claims 13 to 15 where the “connected and making a request” status comprises the following requests:
request to automatically establish an interconnection with mobile telephones, which have made the same request,
request defining the areas of interest
request to change status.

17. Server (2) according to any of the claims 13 to 16, more particularly designed to search for people located in close proximity to each other:
the aforementioned communication network (4) is subdivided into cells (4a), each one corresponding to a certain geographic area;
the aforementioned cells (4a) are identified by a cell number;
the aforementioned server (2) comprises a memory sector (2e) in which the cell numbers (4a) for the aforementioned mobile telephones are stored;
the aforementioned server (2) also comprises the calculation tools (2a) to determine, using the aforementioned cell numbers, which mobile telephones are located in the same cell (4a) or in neighbouring (4a) cells;
the aforementioned server (2) also comprises the downloading tools (2f) to download the aforementioned list (8) or the aforementioned restricted list (9) to the mobile telephone in question by marking with an audio or visual symbol (10), the people whose mobile telephones are located
in the same cell (4a) as the one in which the mobile telephone in question is located, or
in cells (4a) adjoining the one in which the mobile telephone in question is located.
(in such a way that the person using the mobile telephone in question can identify the people located in his geographic area and can contact them in order to meet them).
